(19) United States
(12) Patent Application Publication
(10) Pub. No.: US 2016/0064916 A1
(43) Pub. Date: Mar. 3, 2016

(54) DETECTION CIRCUIT AND SEMICONDUCTOR DEVICE

(71) Applicant: Seiko Instruments Inc., Chiba-shi (JP)

(72) Inventors: Masakazu SUGIURA, Chiba-shi (JP); Atsushi IGARASHI, Chiba-shi (JP); Nao OTSUKA, Chiba-shi (JP)

(21) Appl. No.: 14/837,534

(22) Filed: Aug. 27, 2015

(30) Foreign Application Priority Data
Sep. 1, 2014 (JP) 2014-177504

(51) Int. Cl. H02H 3/08; H02H 3/12

(52) U.S. Cl. CPC H02H 3/08; H02H 3/12

(57) ABSTRACT

Provided is a semiconductor device including a detection circuit in which, even when a load short-circuit detection circuit and a load open-circuit detection circuit perform false detection due to a fluctuation in power supply voltage and the like, an output of a false detection result can be prevented. The detection circuit includes the load short-circuit detection circuit configured to detect a short circuit of a load, the load open-circuit detection circuit configured to detect an open circuit of the load, and a logic circuit configured to output output signals of the load short-circuit detection circuit and the load open-circuit detection circuit to an output terminal of the logic circuit, in which the logic circuit outputs a signal of a non-detection logic to the output terminal when the outputs of the load open-circuit detection circuit and the load short-circuit detection circuit are detection logics.

### RELATED APPLICATIONS

This application claims priority under 35 U.S.C. §119 to Japanese Patent Application No. 2014-177504 filed on Sep. 1, 2014, the entire content of which is hereby incorporated by reference.

### BACKGROUND OF THE INVENTION

1. Field of the Invention

The present invention relates to a detection circuit configured to detect an open circuit and a short circuit of a connected load, and a semiconductor device.

2. Description of the Related Art

FIG. 3 is a circuit diagram of a semiconductor device including a related-art detection circuit. The semiconductor device including the related-art detection circuit includes a MOS transistor 1 connected between a voltage input terminal T1 and a voltage output terminal T2, a control circuit 2, a load short-circuit detection circuit 3 configured to detect a short circuit between a load connected to the voltage output terminal T2 and a ground terminal, a load open-circuit detection circuit 4 configured to detect an open circuit of the load, and a logic circuit 5 configured to output output signals of those detection circuits to an output terminal T3.

In the semiconductor device including the related-art detection circuit, when the load short-circuit detection circuit 3 detects a short circuit between the load connected to the voltage output terminal T2 and the ground terminal, or when the load open-circuit detection circuit 4 detects an open circuit of the load, the logic circuit 5 (OR circuit) outputs the output signal of the detection circuit to the output terminal T3.

In the semiconductor device including the detection circuit, when the detection signal indicating the short circuit or the open circuit of the load is output, the circuit that receives the signal performs a safety process such as blocking a power supply voltage or stopping the operation.

However, the above-mentioned semiconductor device including the detection circuit has the following problem. Specifically, the load short-circuit detection circuit 3 and the load open-circuit detection circuit 4 may perform false detection due to a fluctuation in power supply voltage, for example. Then, the logic circuit 5 (OR circuit) may output the signal to the output terminal T3 despite obvious false detection of simultaneously outputting the detection signals. When performing the safety process, the semiconductor device may stop the operation or be damaged and no longer return to the normal operation.

### SUMMARY OF THE INVENTION

The present invention has been conceived in order to solve the problem described above, and provides a semiconductor device including a detection circuit that does not output a false detection result.

In order to solve the related-art problem, a semiconductor device including a detection circuit according to one embodiment of the present invention has the following configuration.

The detection circuit includes: a load short-circuit detection circuit configured to detect a short circuit of a load; a load open-circuit detection circuit configured to detect an open circuit of the load; and a logic circuit configured to output output signals of the load short-circuit detection circuit and the load open-circuit detection circuit to an output terminal of the logic circuit, in which the logic circuit outputs a signal of a non-detection logic to the output terminal when the outputs of the load open-circuit detection circuit and the load short-circuit detection circuit are detection logics.

According to the semiconductor device including the detection circuit of the one embodiment of the present invention, even when the load short-circuit detection circuit and the load open-circuit detection circuit perform false detection due to a fluctuation in power supply voltage and the like, an output of a false detection result may be prevented.

### BRIEF DESCRIPTION OF THE DRAWINGS

FIG. 1 is a circuit diagram of a semiconductor device including a detection circuit according to an embodiment of the present invention.

FIG. 2 is a circuit diagram for illustrating another example of the semiconductor device including the detection circuit of this embodiment.

FIG. 3 is a circuit diagram of a semiconductor device including a related-art detection circuit.

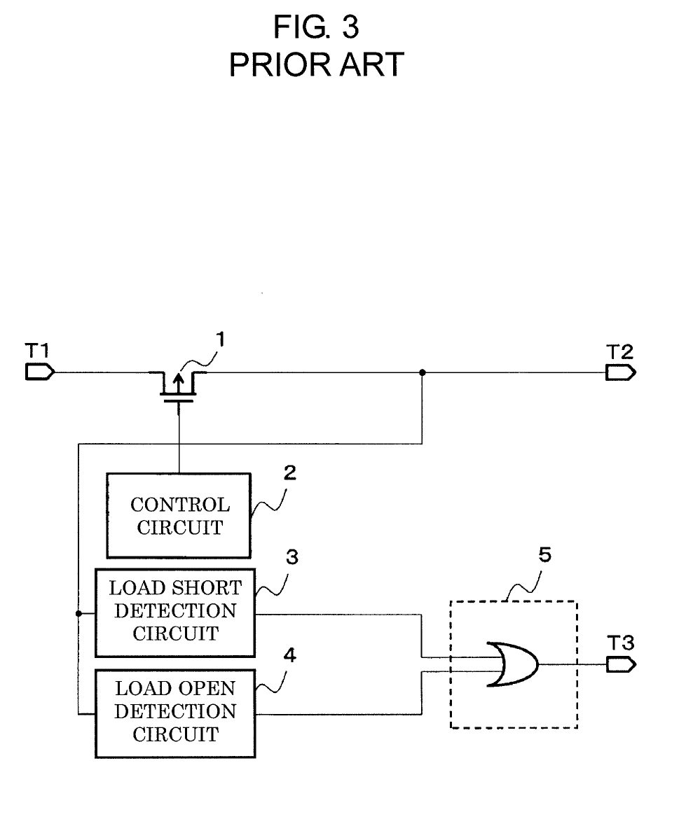

### DETAILED DESCRIPTION OF THE PREFERRED EMBODIMENTS

Now, an embodiment of the present invention is described with reference to the drawings.

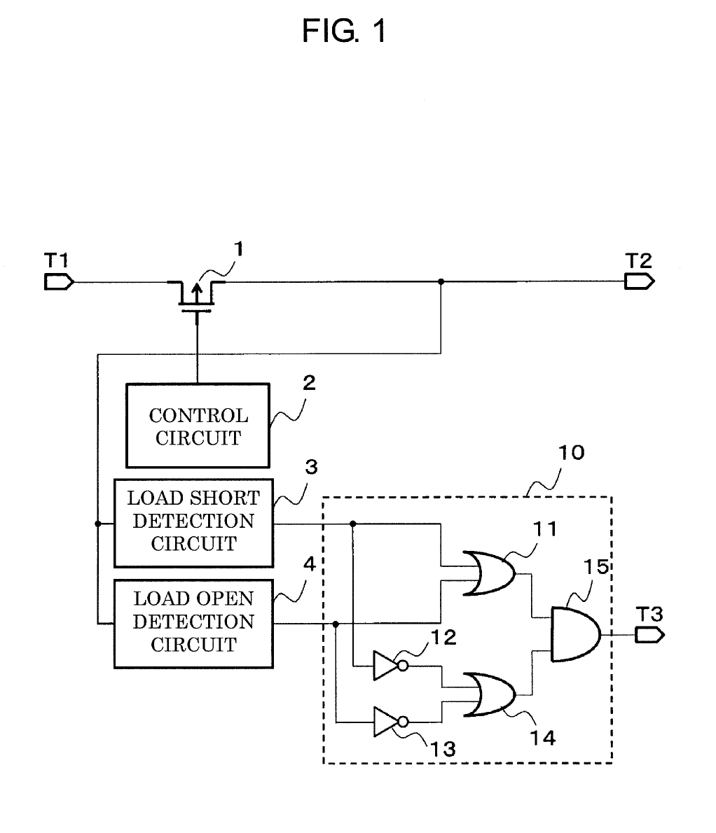

FIG. 1 is a circuit diagram of a semiconductor device including a detection circuit according to this embodiment.

The semiconductor device including the detection circuit of this embodiment includes a voltage input terminal T1, a voltage output terminal T2, an output terminal T3, a MOS transistor 1, a control circuit 2, a load short-circuit detection circuit 3, a load open-circuit detection circuit 4, and a logic circuit 10. The logic circuit 10 includes OR circuits 11 and 14, inverters 12 and 13, and an AND circuit 15.

The detection circuit detects a removal of a load that has been connected to the voltage output terminal T2 (load open circuit) and a short circuit of the load (load short circuit), and outputs a detection signal to the output terminal T3.

The voltage input terminal T1 inputs a power supply voltage. The power supply voltage input to the voltage input terminal T1 is output to the voltage output terminal T2 via the MOS transistor 1. The control circuit 2 controls the MOS transistor 1 to control an output voltage of the voltage output terminal T2. The load short-circuit detection circuit 3 outputs a detection signal when detecting abnormality. The load open-circuit detection circuit 4 outputs a detection signal when detecting abnormality. The logic circuit 10 outputs those detection signals to the output terminal T3. Moreover, the logic circuit 10 outputs those detection signals also to the control circuit 2.

The MOS transistor 1 is connected between the voltage input terminal T1 and the voltage output terminal T2. The control circuit 2 has an output terminal connected to a gate of the MOS transistor 1. The load short-circuit detection circuit 3 has an input terminal connected to the voltage output terminal T2. The load open-circuit detection circuit 4 has an input terminal connected to the voltage output terminal T2. The logic circuit 10 has a first input terminal connected to an output terminal of the load short-circuit detection circuit 3, a second input terminal connected to an output terminal of the load open-circuit detection circuit 4, and an output terminal connected to the output terminal T3. The OR circuit 11 has input terminals connected to the first input terminal and the second input terminal. The inverter 12 has an input terminal connected to the first input terminal. The inverter 13 has an input terminal connected to the second input terminal. The OR circuit 14 has input terminals connected to output terminals of the inverters 12 and 13. The AND circuit 15 has input terminals connected to output terminals of the OR circuits 11 and 14, and an output terminal connected to the output terminal T3.

Next, operation of the detection circuit of this embodiment is described. A description is given with High level detection signals of the load short-circuit detection circuit 3 and the load open-circuit detection circuit 4.

When one of the load short-circuit detection circuit 3 and the load open-circuit detection circuit 4 detects abnormality, an input signal of one of the OR circuits 11 and 14 is High, and hence an output signal is High of a detection logic. Consequently, the AND circuit 15 outputs a High level signal of the detection logic to the output terminal T3.

Next, a description is given of a case where the load short-circuit detection circuit 3 and the load open-circuit detection circuit 4 perform false detection due to a fluctuation in power supply voltage and the like. At this time, the load short-circuit detection circuit 3 and the load open-circuit detection circuit 4 simultaneously output High level detection signals. When the first input terminal and the second input terminal simultaneously input the High level, the OR circuit 11 outputs a High level detection signal, but the OR circuit 14 outputs a non-detection signal of a Low level because both of signals input to the OR circuit 14 are Low. Consequently, the AND circuit 15 outputs a Low level signal of a non-detection logic to the output terminal T3.

As described above, according to the semiconductor device including the detection circuit of this embodiment, even when the load short-circuit detection circuit and the load open-circuit detection circuit perform the false detection due to the fluctuation in power supply voltage and the like, an output of a false detection result can be prevented.

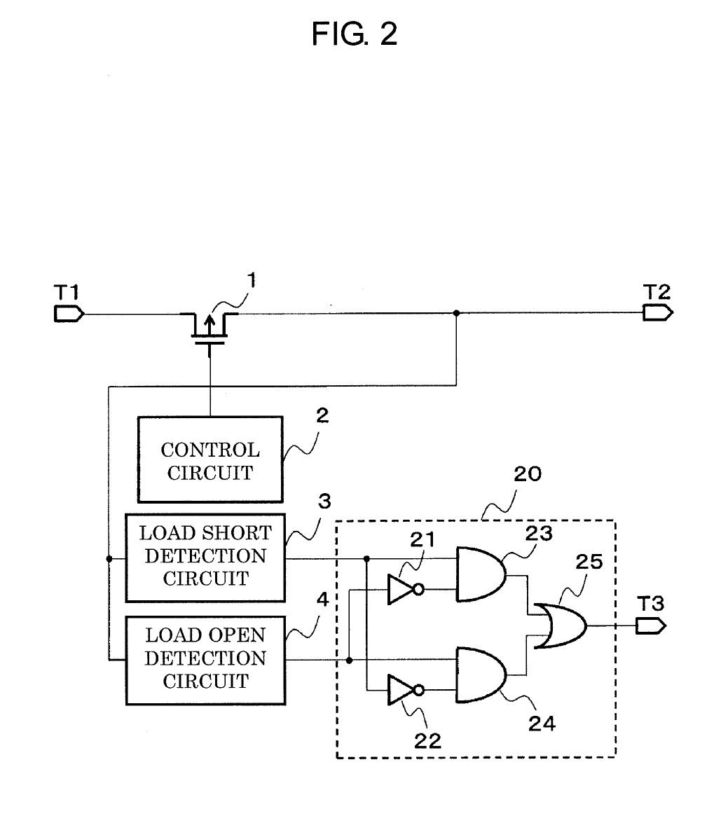

FIG. 2 is a circuit diagram for illustrating another example of the semiconductor device including the detection circuit according to this embodiment.

The semiconductor device including the detection circuit of FIG. 2 includes the voltage input terminal T1, the voltage output terminal T2, the output terminal T3, the MOS transistor 1, the control circuit 2, the load short-circuit detection circuit 3, the load open-circuit detection circuit 4, and a logic circuit 20. The logic circuit 20 includes inverters 21 and 22, AND circuits 23 and 24, and an OR circuit 25.

The logic circuit 20 has a first input terminal connected to the output terminal of the load short-circuit detection circuit 3, a second input terminal connected to the output terminal of the load open-circuit detection circuit 4, and an output terminal connected to the output terminal T3. The inverter 21 has an input terminal connected to the second input terminal. The inverter 22 has an input terminal connected to the first input terminal. The AND circuit 23 has input terminals connected to the first input terminal and an output terminal of the inverter 21. The AND circuit 24 has input terminals connected to the second input terminal and an output terminal of the inverter 22. The OR circuit 25 has input terminals connected to output terminals of the AND circuits 23 and 24, and an output terminal connected to the output terminal T3.

In the logic circuit 20 having the configuration described above, when an output signal of the load open-circuit detection circuit 4 is a detection logic, an output of the load short-circuit detection circuit 3 is set to be a non-detection logic, and on the other hand, when the output signal of the load short-circuit detection circuit 3 is the detection logic, the output of the load open-circuit detection circuit 4 is set to be the non-detection logic.

Consequently, the detection circuit of FIG. 2 outputs a signal of the non-detection logic from the output terminal T3 when the outputs of the load open-circuit detection circuit and the load short-circuit detection circuit are the detection logics. That is, an effect similar to that of the detection circuit of FIG. 1 can be obtained.

What is claimed is:

1. A detection circuit configured to detect an open circuit and a short circuit of a load connected to a voltage output terminal, the detection circuit comprising:
a load short-circuit detection circuit configured to detect the short circuit of the load;
a load open-circuit detection circuit configured to detect the open circuit of the load; and
a logic circuit configured to output, to an output terminal of the logic circuit, an output signal of the load short-circuit detection circuit and an output signal of the load open-circuit detection circuit,
the logic circuit being further configured to output a signal of a non-detection logic from the output terminal when the output signal of the load open-circuit detection circuit and the output signal of the load short-circuit detection circuit are detection logics.

2. A detection circuit according to claim 1,
wherein when the output signal of the load open-circuit detection circuit is the detection logic, the output signal of the load short-circuit detection circuit is set to be the non-detection logic, and
wherein when the output signal of the load short-circuit detection circuit is the detection logic, the output signal of the load open-circuit detection circuit is set to be the non-detection logic.

3. A semiconductor device, comprising the detection circuit of claim 1.

4. A semiconductor device, comprising the detection circuit of claim 2.
